(19) United States
(12) Patent Application Publication
(10) Pub. No.: US 2007/0144995 A1
(43) Pub. Date: Jun. 28, 2007

(54) Operating apparatus for a loading crane

(76) Inventor: Werner Emminger, Lochen (AT)

Correspondence Address: WENDEROTH, LIND & PONACK, L.L.P., 2033 K STREET N. W., SUITE 800, WASHINGTON, DC, 20006-1021, US

(21) Appl. No.: 11/640,279

(22) Filed: Dec. 18, 2006

(30) Foreign Application Priority Data
Dec. 27, 2005 (AT) GM 892/2005

(51) Int. Cl. B66C 23/88

(52) U.S. Cl. 212/278

(57) ABSTRACT

An operating apparatus for a loading crane, comprising a display screen on which a torque exerted by the load and the crane can be represented in relation to its respective highest permissible value, wherein the direction of the plane defined by the crane with respect to a horizontal plane (pivot angle) and the current torque can be displayed together with a curve (21) which represents the highest permissible torque for the entire angular range.

The invention relates to an operating apparatus for a loading crane, comprising a display screen on which a torque exerted by the load and the crane can be represented in relation to its respective highest permissible value.

Limiting the torque exerted on the mounting arrangement of a loading crane is necessary in the sense of an overload safeguard, in order to avoid structural components of the crane from being overstressed. In addition care is to be taken to provide that a vehicle which is carrying the crane and which is possibly provided with a lateral support arrangement is not tilted by the crane or the load.

When movement within the plane of the crane occurs the representation, which is usual at the present time, of the current torque as a percentage of the highest permissible value is easily sufficient to signal to the operator that a given movement could lead to a safety-induced shutdown. A problem arises however when the crane is pivoted about its vertical axis. More specifically, it is generally to be assumed that the permissible tilting movement is angle-dependent. If, when pivoting the crane, a corresponding limit switch is overrun, that therefore involves an abrupt stoppage of the pivoting movement then the operator is not being warned in advance by the display which is usual at the present time.

The invention avoids the indicated disadvantage in that the direction of the plane defined by the crane with respect to a horizontal plane (pivot angle) and the current torque can be displayed together with a curve which represents the highest permissible torque for the entire angular range.

Further details of the invention are described hereinafter with reference to the drawing in which:

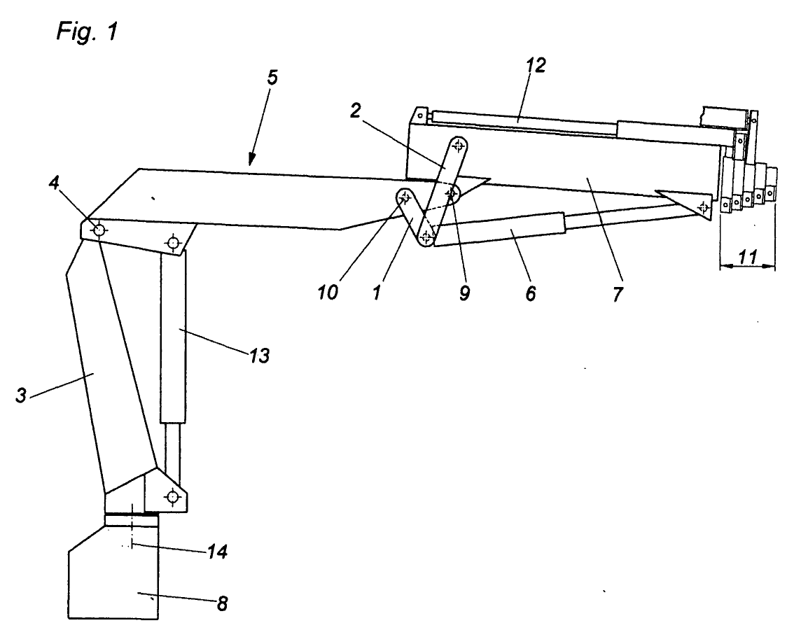

FIG. 1 shows a side view of a conventional loading crane,

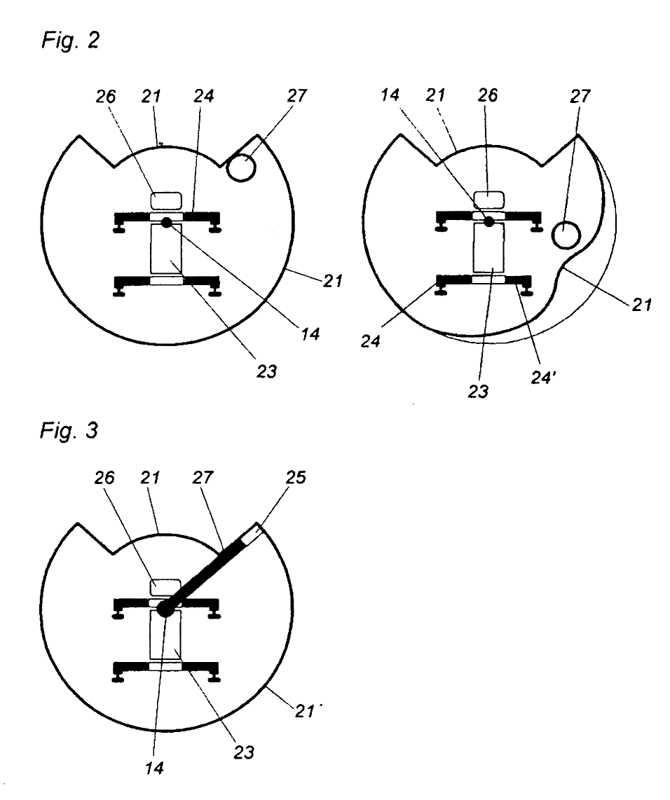

FIG. 2 shows a plan view of a first embodiment in two operating conditions, and

FIG. 3 shows a variant in relation thereto.

The illustrated loading crane has a pillar 3 which is rotatable on a base 8 about a vertical axis 14 and which is inclined rearwardly in the opposite direction to the direction of the jib 5. The pivot axis 4 about which the jib 5 can be moved up and down by means of the unit 13 is displaced with respect to the center of the base 8 somewhat toward that side on which the tilt arm 7 is to be moved past the pillar 3. The tilt arm 7 which carries the multi-part extension arm 11 which is only diagrammatically illustrated is pivotable downwardly about the jib 5, about a central axis 9. The movement of the tilt arm 7 is effected by a hydraulic unit 6 which is fixed on the one hand to the tilt arm 7 and on the other hand to two pairs of pivot levers 1, 2. The pivot levers 1 and 2 are in turn connected either to the jib 5 or to the tilt arm 7.

Each part of the extension arm 11 shown in FIG. 1 can be extended by way of a piston rod 12, only the piston rod for the outermost part of the telescopic extension arm 11 being shown in the drawing.

The pressure in the stroke cylinder 13 usually forms the measurement in respect of the torque exerted by the crane and the load fixed thereto. Any movement in the plane of the crane, that is to say the plane of the drawing in FIG. 1, leads to a steady approach to the highest value which is permissible in terms of overloading or tilting safety. The situation is different in terms of rotational movements about the vertical axis 14. In order to avoid here surprising shutdowns in the pivotal movement of the crane, in accordance with the invention the operator is provided with information which also shows the approach to the permissible highest value of the torque in the case of pivotal movements.

What is essential for the display shown in FIG. 2 is the curve 21 which associates a maximum value of the torque with each angle about the vertical axis 14 of the crane. A symbolic representation of the vehicle 23 with driving cab 26 and lateral support cantilever arms 24 facilitates orientation in that respect. The marking 27 indicates the direction of the crane and also the direction from the axis 14 towards the marking 27. The radial spacing of that marking 27 however does not correspond to the horizontal projection of the crane tip, rather it specifies the current torque on the scale of the curve 21. If now the operator pivots the crane towards the left in FIG. 2 in the anti-clockwise direction it becomes obvious to him that a further movement would lead into the restricted region in front of the driving cab 26. In the situation at the right in FIG. 2, in the same manner the short extension length of the support cantilever arm 24′ in the right rear region of the vehicle means that there is an increased risk of tilting so that only a slight pivotal movement in the clockwise direction is possible.

As FIG. 3 shows, the direction of the crane can also be characterised by a radius extending from the axis 14, in the form of a bar 25. The length of that bar can be selected to be constant or proportional to the spacing of the crane tip from the axis 14. Once again however the marking 27 is essential—here the limit between the filled and unfilled parts of the bar 25—which indicates how far the arrangement is, from the highest permissible torque defined by the curve 21.

1. An operating apparatus for a loading crane, comprising a display screen on which a torque exerted by the load and the crane can be represented in relation to its respective highest permissible value, wherein the direction of the plane defined by the crane with respect to a horizontal plane (pivot angle) and the current torque can be displayed together with a curve which represents the highest permissible torque for the entire angular range.

2. An operating apparatus according to claim 1 wherein the torque can be displayed as a spacing from the pivot axis of the crane.

3. An operating apparatus according to claim 1 wherein there is additionally provided a plan view on to the vehicle and its supports.

4. An operating apparatus according to claim 3 wherein the crane is symbolised by a bar at which the current torque can be read off.

5. An operating apparatus according to claim 2 wherein there is additionally provided a plan view on to the vehicle and its supports.
